(19) United States
(12) Patent Application Publication
(10) Pub. No.: US 2026/0159050 A1
(43) Pub. Date: Jun. 11, 2026

(54) BRAKE SIGNAL TRANSMITTER FOR AN ELECTROPNEUMATIC AND/OR ELECTROMECHANICAL BRAKE SYSTEM

(71) Applicant: ZF CV Systems Global GmbH, Bern (CH)

(72) Inventors: Peter Beier, Wunstorf (DE); Jan Cohrs, Wietzendorf (DE); Christoph Moritz, Hannover (DE); Johannes Leers, Wennigsen (Deister) (DE)

(21) Appl. No.: 19/127,185

(22) PCT Filed: Nov. 3, 2023
(86) PCT No.: PCT/EP2023/080668

§ 371 Date: May 5, 2025

(30) Foreign Application Priority Data
Nov. 8, 2022 (DE) 10 2022 129 461.7

(51) Int. Cl. B60T 8/171; B60T 7/04; B60T 17/22

(52) U.S. Cl. CPC B60T 8/171; B60T 7/042; B60T 17/22; B60T 2220/04; B60T 2270/413

(57) ABSTRACT

A brake signal transmitter (100), for an electropneumatic and/or electromechanical brake system (250) of a vehicle (200a), includes a movably arranged plunger piston (105), a first displacement sensor (106a), and a second displacement sensor (106b), which is redundant in relation to the first displacement sensor (106a), for detecting a movement (160) of the plunger piston (105). A signal transducer device (150) having two redundant signal transducers (155) reads out the detected movement (160). The brake signal transmitter (100) has a pressure space (120) and a sensor device (125) for sensing a measurement variable (161) relating to the pressure space (120), and the movement (160) of the plunger piston (105) can be determined by sensing of the measurement variable (161).

### FIELD

The present disclosure relates to a brake signal transmitter for an electropneumatic brake system and/or for an electromechanical brake system of a vehicle, in particular utility vehicle. The present disclosure also relates to an electropneumatic and/or electromechanical brake system for a vehicle, in particular utility vehicle, and to a vehicle, in particular utility vehicle.

### BACKGROUND

Such a brake signal transmitter is configured to control a braking force for braking the vehicle, in particular utility vehicle. In the case of an electropneumatic brake system, the level of the braking forces in two braking circuits is selectively electronically or pneumatically controllable. The braking forces are commonly controlled electronically during normal operation, with a switch to pneumatic control being made only if a fault occurs in the electronic brake control device. In the case of an electromechanical brake system of a motor vehicle, the level of the braking forces is selectively electronically or mechanically controllable. The braking forces are commonly controlled electronically during normal operation, with a switch to alternative electronic control being made only if a fault occurs in the electronic brake control device.

A brake control pressure is set in the brake signal transmitter, from a reservoir pressure prevailing at an inlet side, in accordance with a stroke or a movement of a plunger piston that is operatively connected to the brake pedal of the motor vehicle, said brake control pressure being introduced as a pilot control pressure into a pneumatic relay valve of the associated brake system and being converted into a braking force that acts in the associated wheel brake cylinders.

In the prior art, the movement is determined by way of an electronic displacement sensor. The displacement sensor commonly operates contactlessly and is inductively or magnetically influenced by a ferromagnetic or permanently magnetic signal generator that is fastened directly or indirectly to the plunger piston. The displacement sensor measures the movement of the plunger piston, and this is transmitted for example in the form of a pulse-width-modulated signal to an electronic control unit of an electronic brake control device. The electronic control unit introduces a corresponding control current into an electromagnetic relay valve of the associated brake circuit, said control current being converted into a braking force that acts in the associated wheel brake cylinders.

In comparison with pneumatic control of the brake pressures, electronic control of the braking forces has the advantages of faster response behavior to a changed actuation position of the brake pedal and more exact metering of the acting braking forces.

By each being separately supplied with electrical power and connected to different electronic control units, the displacement sensors can be operated independently of one another, and the sensor signals thereof can be evaluated independently of one another. This means that the two displacement sensors can be used redundantly in relation to one another, such that, in the event of failure of one of these two displacement sensors, the sensor data from the other displacement sensor are available for the control of the relay valves of one or more brake circuits of a vehicle.

Such a brake signal transmitter is disclosed in DE 10 2019 129 153 A1. DE 10 2019 129 153 A1 discloses a footbrake module of an electropneumatic brake system of a motor vehicle having at least two pneumatic brake circuits, said footbrake module being actuatable by way of a brake pedal, and said footbrake module having a pneumatic part, which has a pneumatic brake control valve, and an electrical part, which has at least one electrical switch and at least one electronic displacement sensor, wherein the electrical switch operates contactlessly, and in the case of an embodiment of the footbrake module having two displacement sensors, these each have a separate electrical supply and are connected to different electronic control units.

DE 101 16 203 A1 discloses a hydraulic vehicle brake system having wheel brakes for four wheels that are distributed among a first and a second vehicle axle, having a hydraulic external energy source and electrically controllable service brake valve assemblies arranged between said energy source and the wheel brakes, having a brake signal transmitter, which is actuatable by way of a brake pedal, for performing service braking operations by way of external hydraulic energy using the service brake valve assemblies, and having a two-cylinder master brake cylinder, which is actuatable by way of the brake pedal, for performing a secondary braking operation using muscle power.

DE 10 2014 010 815 A1 discloses an electropneumatic control valve, in particular electropneumatic two-circuit brake signal transmitter in a compressed-air brake system of a vehicle, for adjusting a brake pressure, corresponding to a desired braking action, in a first brake circuit and in a second brake circuit, said electropneumatic control valve having a first valve system, which is arranged in an upper housing region and a middle housing region of a control valve housing and is actuatable by way of a pedal, and having a second valve system, which is arranged in a lower housing region of the control valve housing and is actuatable pneumatically and/or mechanically by way of the first valve system, wherein, in the first valve system, a valve piston is arranged in the control valve housing and is axially movable counter to a spring force by way of a plunger piston, wherein, in a receiving device in the region of the plunger piston or of the valve piston of the first valve system, an electrical switch is provided for registering the start of actuation of the control valve and/or a displacement sensor is provided for the purposes of outputting an electrical displacement signal for registering the actuation travel of the plunger piston, and wherein the electrical switch and/or the displacement sensor are connected to an electronic and/or electromechanical measurement unit. In this control valve, the electronic measurement unit is designed as an application-specific sub-unit of an electronically controlled brake system and is arranged in a partially closed electronics housing, and the electronics housing is exchangeably connectable to the receiving device.

### SUMMARY

For an electropneumatic brake system without pneumatic redundancy or for an electromechanical brake system, it may be necessary, for reliable operation of the brake system, to provide a purely electrical braking signal generator or brake signal transmitter, which exhibits improved redundancy.

It is therefore the object of the present disclosure to enhance the prior art and provide an improved brake signal transmitter. An embodiment of the present disclosure may in particular achieve the object of providing an electrical brake signal transmitter having improved redundancy for determining a braking demand or a pedal actuation.

The object is achieved by way of a brake signal transmitter according to the present disclosure. The present disclosure also specifies preferred refinements of the present disclosure.

According to the present disclosure, a brake signal transmitter for an electropneumatic and/or electromechanical brake system of a vehicle, in particular utility vehicle, is provided. The brake signal transmitter includes: a movably arranged plunger piston, a first displacement sensor and a second displacement sensor, which is redundant in relation to the first displacement sensor, for detecting a movement of the plunger piston, and a signal transducer device having two redundant signal transducers for reading out the detected movement, wherein the brake signal transmitter has a pressure space and a sensor device for sensing a measurement variable relating to the pressure space, and wherein the movement of the plunger piston can be determined by sensing of the measurement variable.

The plunger piston or plunger can be moved when a brake pedal is actuated. The movement or stroke of the plunger piston that is thus achievable may be definitive of the braking action to be achieved. In order that a braking action can be reliably determined on the basis of the movement of the plunger piston, the brake signal transmitter comprises the two displacement sensors, which are each configured to detect the displacement of the plunger piston, and which are redundant in relation to one another.

It has been identified here that such a brake signal transmitter should be usable even in a brake system without pneumatic redundancy. It is thus possible that a pneumatic conversion of the movement into a braking force by way of a pneumatic relay valve can be dispensed with. The rest of a mechanism of the brake signal transmitter may serve for imparting a pedal feel to the driver in order to provide feedback relating to the braking operation, which feedback is perceptible to the driver. Owing to the absence of pneumatic redundancy, the safety and reliability of the operation of the brake signal transmitter can be increased by virtue of the brake signal transmitter having the sensor device and the pressure space. Here, the movement of the plunger piston can be determined by the sensing of the measurement variable relating to the pressure space. In other words, a movement of the plunger piston causes a change in a measurable variable, or in the measurement variable, of the pressure space. The sensor device is configured to generate, in accordance with the measurement variable, a signal from which the movement of the plunger piston can be inferred. The sensor device and the detection of the measurement variable thus create a possibility, in addition to the displacement sensors, for determining the movement of the plunger piston.

The sensor device preferably comprises a first pressure sensor for sensing a pressure within the pressure space. It has been identified here that a movement of the plunger piston can cause a change in the pressure within the pressure space. Here, the change in the pressure may in particular be dependent on an extent, for example a length, of the movement. The change in the pressure can thus provide information regarding the movement or the stroke of the plunger piston. The first pressure sensor thus creates a possibility, in addition and as an alternative to the displacement sensors, for determining the movement of the plunger piston.

In particular, the first pressure sensor may be designed as a PWM (pulse width modulation) pressure sensor, wherein the first pressure sensor can provide the output signal as a pulse-width-modulated signal. The use of the PWM pressure sensor can assist in achieving compliance with the requirements regarding the functional safety of the corresponding brake system. For example, the use of the PWM pressure sensor can assist in achieving compliance with the requirements of ISO 26262.

The sensor device preferably comprises a second pressure sensor, which is redundant in relation to the first pressure sensor, for sensing a pressure within the pressure space. Here, the second pressure sensor is designed analogously to the first pressure sensor. The reliability of the sensing of the pressure can thus be further improved. Owing to the redundancy, one of the pressure sensors can reliably measure the pressure in the pressure space even if the other of the pressure sensors is disrupted or faulty and/or has failed.

In a preferred embodiment, the second pressure sensor may be designed as a PWM (pulse width modulation) pressure sensor, wherein the second pressure sensor can provide the output signal as a pulse-width-modulated signal. The use of the PWM pressure sensor can assist in achieving compliance with the requirements regarding the functional safety of the corresponding brake system. For example, the use of the PWM pressure sensor can assist in achieving compliance with the requirements of ISO 26262.

The signal transducer device is preferably configured to carry out a plausibility check on the basis of the pressure sensed by the first pressure sensor and a movement detected by the first displacement sensor, and to carry out a plausibility check on the basis of the pressure sensed by the second pressure sensor and a movement detected by the second displacement sensor. A link is thus provided between the first pressure sensor and the first displacement sensor and between the second pressure sensor and the second displacement sensor. The movement of the plunger piston as detected by one of the displacement sensors, and the measurement of the pressure by the corresponding pressure sensor, can thus be checked for plausibility. Here, one of the displacement sensors may be used to check the plausibility of the measurement of the corresponding pressure, and/or the measurement of the pressure by way of one of the pressure sensors may be used to check the plausibility of the movement detected by way of the associated displacement sensor. The plausibility check may comprise a check and/or a correction of a detected value.

The signal transducer device is preferably configured to carry out a plausibility check on the basis of the measurement variable relating to the pressure space and the movement detected by the displacement sensors. It has been found here that the measurement variable can be used to check the movement detected by the displacement sensors and/or by one of the displacement sensors. Alternatively or in addition, the sensor device or the functioning thereof may be checked on the basis of the movement detected by the displacement sensors and/or by one of the displacement sensors.

A volume and/or a pressure of the pressure space is preferably reversibly variable in accordance with the movement of the plunger piston. It is thus possible, for example, for the volume and the pressure of the pressure space to be changed by way of a pedal actuation. In the process, a gas within the pressure space is brought from a rest state into a compressed state. After the pedal actuation is withdrawn, the rest state of the pressure space can be restored, in the case of which the volume and/or the pressure assume a value that was assumed prior to the pedal actuation. The pressure and/or the volume, and the changes thereof, are measurement variables that can be measured efficiently and precisely. Owing to the reversible variability of the pressure and/or of the volume and thus of the measurement variable, the movement of the plunger piston can be reliably and reproducibly determined by way of the sensor device.

Preferably, each of the displacement sensors and the sensor device have mutually independent energy supplies. It can thus be achieved that each of the displacement sensors and the sensor device can be operated independently of one another. Here, the energy supply may in particular include electrical lines and/or an energy storage device. Optionally, the sensor device has a plurality of pressure sensors, and each of the pressure sensors has an independent energy supply. The pressure sensors can thus allow a measurement of a pressure in the pressure space even in the event of failure of the energy supply of one of the pressure sensors.

Preferably, the brake signal transmitter has a housing and a piston that is deflectable by the movement of the plunger piston, and the pressure space is formed by a volume that is delimited by the housing and the piston. The pressure space can thus be measurably influenced directly by a movement of the plunger piston, because a movement of the plunger piston causes a deflection of the piston and thus changes the volume that defines the pressure space.

According to one aspect of the present disclosure, an electropneumatic and/or electromechanical brake system for a vehicle, in particular utility vehicle, is provided. The brake system includes the brake signal transmitter described above. The brake signal transmitter may have one of the above-described optional and/or advantageous features in order to generate an associated technical effect.

According to one aspect of the present disclosure, a vehicle, in particular utility vehicle, is provided. The vehicle, in particular utility vehicle, includes the above-describe brake signal transmitter and/or the above-described brake system. The brake signal transmitter may have one of the above-described optional and/or advantageous features in order to generate an associated technical effect.

### BRIEF DESCRIPTION OF THE DRAWINGS

Further advantages and features of the present disclosure and the technical effects thereof will become apparent from the figures and from the description of the preferred embodiments that are shown in the figures. In the figures:

FIG. 1 is a schematic illustration of a vehicle, in particular utility vehicle, according to an embodiment of the invention;

FIG. 2 is a schematic illustration of a longitudinal section through a brake signal transmitter according to an embodiment of the invention; and

FIG. 3 is a schematic illustration of a brake signal transmitter according to an embodiment of the invention.

### DETAILED DESCRIPTION

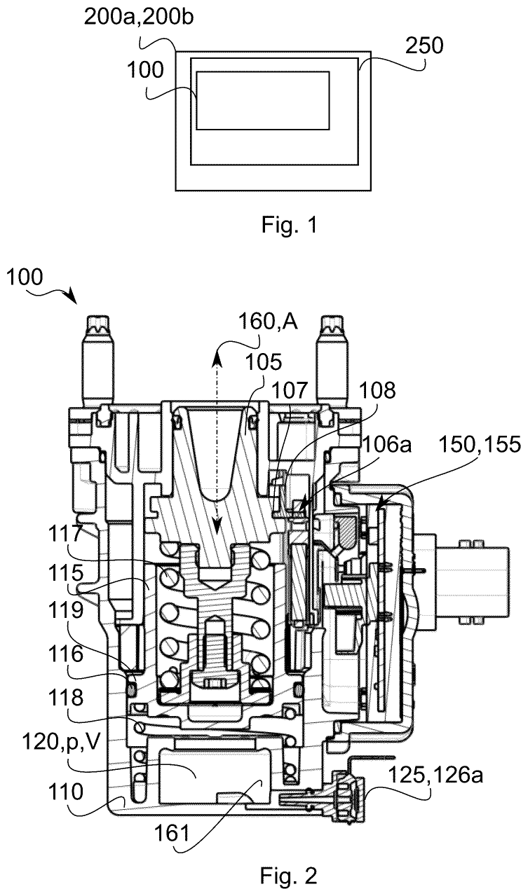

FIG. 1 is a schematic illustration of a vehicle 200a, in particular utility vehicle 200b, according to an embodiment of the invention. The vehicle 200a, in particular utility vehicle 200b, will hereinafter be referred to as vehicle 200a, 200b. The vehicle 200a, 200b is a land vehicle.

The vehicle 200a, 200b includes an electropneumatic and/or electromechanical brake system 250. The brake system 250 includes one or more brakes (not shown) for braking in each case one wheel (not shown) of the vehicle 200a, 200b and thus braking the vehicle 200a, 200b. To brake the vehicle 200a, 200b, the brake system 250 is configured to apply a braking force to the brakes in order to generate the braking action. The braking force corresponds to a braking demand, for example in the form of a pedal actuation by a driver, that is to say an actuation of a brake pedal.

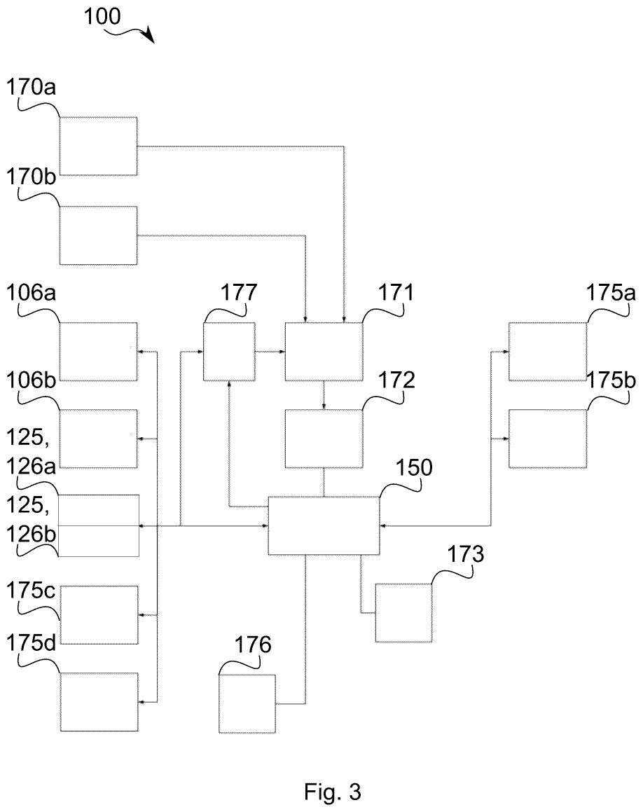

The brake system 250 includes a brake signal transmitter 100. The brake signal transmitter 100 is configured to detect a pedal actuation and to contribute to a conversion of the pedal actuation into a braking force. Such a brake signal transmitter 100 will be described with reference to FIGS. 2 and 3.

FIG. 2 is a schematic illustration of a longitudinal section through a brake signal transmitter 100 according to an embodiment of the present disclosure.

The brake signal transmitter 100 is a brake signal transmitter for an electropneumatic and/or electromechanical brake system 250 of a vehicle 200a, in particular utility vehicle 200b. Such a brake system 250 and such a vehicle 200a, 200b have been described with reference to FIG. 1.

The brake signal transmitter 100 according to FIG. 2 includes a movably arranged plunger piston 105. The plunger piston 105 is rotationally symmetrical and is configured to perform a movement 160 along an axis A, said movement being indicated by a double arrow with a dash-dotted line. The axis A is for example an axis of symmetry of the plunger piston 105 and/or a longitudinal axis of the brake signal transmitter 100. The movement 160 of the plunger piston 105 may be effected by the actuation of a pedal, wherein the movement 160 is a stroke of the plunger piston 105 in accordance with the pedal actuation.

The plunger piston 105 has an engagement member 107. The engagement member 107 is configured to be operatively connected to a first slide 108. The first slide 108 is movable parallel to the axis A. The engagement member 107 and the first slide 108 may for example be interlockingly connected to one another, whereby the slide 108 is movable by way of a movement 160 of the plunger piston 105. A movement 160 of the plunger piston 105 corresponds to a movement of the first slide 108.

The brake signal transmitter 100 has a first displacement sensor 106a for detecting the movement 160 of the plunger piston 105. The first displacement sensor 106a measures the movement of the slide 108 and thus indirectly measures the movement 160 of the plunger piston 105. The slide 108 is designed as a signal generator for the first displacement sensor 106a. The first displacement sensor 106a operates contactlessly and is inductively or magnetically influenced by the ferromagnetic or permanently magnetic signal generator. The first displacement sensor 106a measures the movement 160 of the plunger piston 105, and this is transmitted for example in the form of a pulse-width-modulated signal to a signal transducer device 150 and/or an electronic control unit of an electronic brake control device.

The brake signal transmitter 100 has a second displacement sensor 106b which is redundant in relation to the first displacement sensor 106a (see FIG. 3). The brake signal transmitter 100 furthermore has, analogously to the first slide 108, a second slide (not explicitly shown; refer to first slide 108) that is operatively connected to the engagement member 107. The second slide is mounted so as to be movable parallel to the axis A. The second displacement sensor 106b measures the movement of the second slide and thus indirectly measures the movement 160 of the plunger piston 105. The second displacement sensor 106b and the second slide are for example arranged in front of or behind the plane of the drawing in FIG. 2, and are rotationally offset with respect to the first slide 108 and the first displacement sensor 106a by 90° about the axis A.

The brake signal transmitter 100 includes the signal transducer device 150 having two redundant signal transducers 155 for reading out the detected movement 160. For this purpose, a first voltage transducer 155 is connected to the first displacement sensor 106a in order to read out the movement 160 detected by the first displacement sensor 106a. A second voltage transducer 155 is connected to the second displacement sensor 106b in order to read out the movement 160 detected by the second displacement sensor 106b.

The brake signal transmitter includes a piston 115 which is deflectable by the movement 160 of the plunger piston 105. A movement 160 of the plunger piston 105 along the axis A causes a deflection of the piston 115 along the axis A. Here, the movement 160 of the plunger piston 105 causes a compression of a first spring 117, which in turn imparts a restoring force to the plunger piston 105. The deflection of the piston 115 causes a compression of a second spring 118, which in turn imparts a restoring force to the piston 115 and indirectly via the first spring 117 to the plunger piston 105. By way of the interaction of the first spring 117 and the second spring 118, or of their forces that act on the plunger piston 105, a driver of the vehicle 200a, 200b can be provided with feedback corresponding to the pedal actuation and/or braking action.

The brake signal transmitter 100 includes a pressure space 120. The pressure space 120 is formed by a volume V that is delimited by the housing 110 and the piston 115. In order to achieve and/or improve the leak-tightness of the pressure space 120, the brake signal transmitter 100 includes a seal 116 which is arranged in a recess 119 of the piston 115 and between the piston 115 and the housing 110 and which prevents a flow of air out of the pressure space 120.

The pressure space has a volume V and a gas that is at a pressure p. The volume V and the pressure p of the pressure space 120 are reversibly variable in accordance with the movement 160 of the plunger piston 105. A pedal actuation causes the volume V of the pressure space 120 to be reduced in relation to a rest state without a pedal actuation, owing to a deflection of the piston 115 along the axis A. Here, the pressure p within the pressure space 120 may increase in relation to the rest state. After the pedal actuation is withdrawn, the plunger piston 105 can be deflected into the rest position by the restoring or elastic forces that act on the plunger piston 105. The restoring forces that act on the plunger piston 105 arise from the first spring 117, the second spring 118, and a pressure force that results from the pressure p within the pressure space 120. Here, the piston 115 is deflected into the rest position, and the volume V and the pressure p of the pressure space 120 assume their original values or rest values, that is to say the values that are assumed in the absence of a pedal actuation and thus in the absence of a deflection of the piston 115 or in the absence of a movement 160 of the plunger piston 150.

The brake signal transmitter 100 includes a sensor device 125 for sensing a measurement variable 161 relating to the pressure space 120. Here, the movement 160 of the plunger piston 105 can be determined by sensing of the measurement variable 161. The signal transducer device 150 is configured to carry out a plausibility check on the basis of the measurement variable 161 relating to the pressure space 120 and the movement 160 detected by the displacement sensors 106.

The sensor device 125 includes a first pressure sensor 126a for sensing the pressure p within the pressure space 120. The sensor device 125 includes a second pressure sensor 126b (see FIG. 3), which is redundant in relation to the first pressure sensor 126a, for sensing a pressure p within the pressure space 120. Here, the measurement variable 161 is the pressure p. The pressure p or the measurement variable 161 is measured redundantly by the first pressure sensor 126a and the second pressure sensor 126b.

The signal transducer device 150 is configured to carry out a plausibility check on the basis of the pressure p sensed by the first pressure sensor 126a and a movement 160 detected by the first displacement sensor 106a, and to carry out a plausibility check on the basis of the pressure p sensed by the second pressure sensor 126b and a movement 160 detected by the second displacement sensor 106b. To increase safety and be able to carry out a plausibility check, the pressure sensors 126a, 126b are implemented in the pressure space 120 under the piston 115.

Each of the displacement sensors 106 and the sensor device 125, or the first pressure sensor 126a and the second pressure sensor 126b, have mutually independent energy supplies 170a, 170b (see FIG. 3).

In an alternative embodiment, the sensor device 125 may include a force sensor for detecting the force transmitted by the piston 115. Here, owing to the springs 117, 118, the force is representative of the movement 160 of the plunger piston 105. Alternatively or in addition, the sensor device 125 may be configured for capacitive measurement for the purposes of detecting the deflection of the piston 115. Alternatively or in addition, the sensor device 125 may be configured to measure the deflection of the piston 115 by optical measurement, for example. Here, the pressure space 120 may for example be connected by way of a membrane to the external surroundings of the brake signal transmitter 100 in order to be able to reconcile demands on the geometry of the housing 110 with the sensor device 125.

FIG. 3 is a schematic illustration of a brake signal transmitter 100 according to an embodiment of the invention. The illustration of the brake signal transmitter 100 in FIG. 3 will be described with reference to FIG. 2.

The brake signal transmitter 100 includes two mutually independent, that is to say redundant, energy supplies 170a, 170b. The energy supplies 170a, 170b are each connected, via mutually independent electrical lines, to a voltage transducer 171 for providing electrical energy. The voltage transducer is connected via a safety controller 172 to the signal transducer device 150. Electrical energy can thus be applied to the signal transducer device 150 for the purposes of operating the signal transducer device 150.

The signal transducer device 150 has a communication connection to a first system bus 175a, a second system bus 175b, a first vehicle bus 175c and a second vehicle bus 175d.

The signal transducer device 150 is connected via each of the first system bus 175a and the second system bus 175b to a control unit of the brake system 250. For this purpose, the first system bus 175a and the second system bus 175b may for example each be a LIN bus. The first system bus 175a and the second system bus 175b are for example buses of the brake system 250.

The signal transducer device 150 is connected via each of the first vehicle bus 175c and the second vehicle bus 175d to a control unit of the vehicle 100a, 100b. For this purpose, the first vehicle bus 175c and the second vehicle bus 175d may for example each be a CAN bus.

The brake signal transmitter 100 includes a monitoring device 173, which has a communication connection to the signal transducer device 150, for monitoring the function of the signal transducer device 150.

The brake signal transmitter 100 includes a switching device 177 for switching operating states of the voltage transducer 171. For this purpose, a signal from the signal transducer device 150, the first vehicle bus 175c, the second vehicle bus 175d and/or the sensor device 125 may be applied to the switching device 177. For this purpose, the switching device 177 has a communication connection to the signal transducer device 150 and to the sensor device 125.

The brake signal transmitter 100 has a memory 176, for example an EEPROM, in order to store and provide data that can be used for the functioning of the brake signal transmitter 100 and in particular of the signal transducer device 150.

The signal transducer device 150 has a communication connection to the displacement sensors 106a, 106b for the purposes of reading out a movement 160 of the plunger piston 105 as detected by the displacement sensors 106a, 106b. A connection between the energy supply 170a, 170b and the displacement sensors 106a, 106b is provided via the signal transducer device 150. The supply of electrical energy to the displacement sensors 106a, 106b is thus implemented centrally via the signal transducer device 150. For this purpose, the signal transducer device 150 may have a redundant wiring arrangement and/or voltage transducer. The first displacement sensor 106a may be connected to the first energy supply 170a in order to be supplied with electrical energy, and the second displacement sensor 106b may be connected to the second energy supply 170b in order to be supplied with electrical energy.

The signal transducer device 150 has a communication connection to the sensor device 125 for the purposes of reading out a measurement variable 161 sensed by the sensor device 125. Here, the sensor device 125 includes the first pressure sensor 126a and the second pressure sensor 126b. A connection between the energy supply 170a, 170b and the pressure sensors 126a, 126b is not explicitly shown in FIG. 3. The first pressure sensor 126a may be connected to the first energy supply 170a, or to a third energy supply, in order to be supplied with electrical energy, and the second pressure sensor 126b may be connected to the second energy supply 170b, or to a fourth energy supply, in order to be supplied with electrical energy. Here, the third energy supply and the fourth energy supply may be redundant in relation to one another, in relation to the first energy supply 170a and in relation to the second energy supply 170b.

### Reference Signs (Part of the Description)

100 Brake signal transmitter
105 Plunger piston
106a Displacement sensor
106b Displacement sensor
107 Engagement member
108 Slide
110 Housing
115 Piston
116 Seal
117 First spring
118 Second spring
119 Recess
120 Pressure space
125 Sensor device
126a First pressure sensor
126b Second pressure sensor
150 Signal transducer device
155 Signal transducer
160 Movement
161 Measurement variable
162 Deflection
170a Energy supply
170b Energy supply
171 Voltage transducer
172 Safety controller
173 Monitoring device
175a System bus
175b System bus
175c Vehicle bus
175d Vehicle bus
176 Memory
177 Switching device
200a Vehicle
200b Utility vehicle
250 Brake system
A Axis
p Pressure
V Volume

1. A brake signal transmitter (100) for an electropneumatic and/or electromechanical brake system (250) of a vehicle (200a), comprising:
a plunger piston (105) configured for movement,
a first displacement sensor (106a) and a second displacement sensor (106b), which is redundant in relation to the first displacement sensor (106a), that detect a movement (160) of the plunger piston (105),
a signal transducer device (150) having two redundant signal transducers that read out (155) the movement (160) detected by the first and second displacement sensors,
wherein the brake signal transmitter (100) has a pressure space (120) and a sensor device (125) that senses a measurement variable (161) relating to the pressure space (120),
wherein the movement (160) of the plunger piston (105) is determined by sensing of the measurement variable (161).

2. The brake signal transmitter (100) as claimed in claim 1, wherein the sensor device (125) includes a first pressure sensor (126a) that senses a pressure (p) within the pressure space (120).

3. The brake signal transmitter (100) as claimed in claim 2, wherein the sensor device (125) includes a second pressure sensor (126b), which is redundant in relation to the first pressure sensor (126a), that senses a pressure (p) within the pressure space (120).

4. The brake signal transmitter as claimed in claim 3, wherein the signal transducer device (150) carries out a plausibility check on the basis of the pressure (p) sensed by the first pressure sensor (126a) and a movement (160) detected by the first displacement sensor (106a), and carries out a plausibility check on the basis of the pressure (p) sensed by the second pressure sensor (126b) and a movement (160) detected by the second displacement sensor (106b).

5. The brake signal transmitter (100) as claimed claim 1, wherein the signal transducer device (150) is configured to carry out a plausibility check on the basis of the measurement variable (161) relating to the pressure space (120) and the movement (160) detected by the displacement sensors (106).

6. The brake signal transmitter (100) as claimed in claim 1, wherein a volume (V) and/or a pressure (p) of the pressure space (120) is reversibly variable in accordance with the movement (160) of the plunger piston (105).

7. The brake signal transmitter (100) as claimed in claim 1, wherein each of the first displacement sensor (106a), the second displacement sensor (106b) and the sensor device (125) have mutually independent energy supplies (170a, 170b).

8. The brake signal transmitter (100) as claimed in claim 1, wherein the brake signal transmitter has a housing (110) and a piston (115) that deflects based on the movement (160) of the plunger piston (105), and the pressure space (120) is formed by a volume (V) that is delimited by the housing (110) and the piston (115).

9. An electropneumatic and/or electromechanical brake system (250) for a vehicle (200a) comprising the brake signal transmitter (100) as claimed in claim 1.

10. A vehicle (200a) comprising a brake signal transmitter (100) as claimed in claim 8 and/or a brake system (250) as claimed in claim 9.

11. A vehicle (200a) comprising a brake system (250) as claimed in claim 9.

12. The brake signal transmitter (100) as claimed in claim 1, wherein the plunger piston (105) includes an engagement member (107) operatively connected to a first slide (108), wherein the first slide (108) moves with the plunger piston.

13. The brake signal transmitter (100) as claimed in claim 12, wherein the first displacement sensor measures movement of the first slide.

14. The brake signal transmitter (100) as claimed in claim 13, wherein the engagement member (107) is operatively connected to a second slide, wherein the second slide moves with the plunger piston.

15. The brake signal transmitter (100) as claimed in claim 14, wherein the second displacement sensor measures movement of the second slide, wherein the first and second slides are disposed in a radially offset manner about the movement axis of the plunger piston.

16. A brake signal transmitter (100) for an electropneumatic and/or electromechanical brake system (250) of a vehicle (200a), comprising:
a plunger piston (105) configured for axial movement,
a first displacement sensor (106a) and a second displacement sensor (106b), which is redundant in relation to the first displacement sensor (106a), that detect a movement (160) of the plunger piston (105),
a signal transducer device (150) having two redundant signal transducers that read out (155) the movement (160) detected by the first and second displacement sensors,
wherein the brake signal transmitter (100) has a pressure space (120), a first pressure sensor, and a second pressure sensor that each sense a pressure (p) within the pressure space (120)
wherein the movement (160) of the plunger piston (105) is determined by sensing of the pressure (p).

17. The brake signal transmitter as claimed in claim 16, wherein the signal transducer device (150) carries out a plausibility check on the basis of the pressure (p) sensed by the first pressure sensor (126a) and a movement (160) detected by the first displacement sensor (106a), and carries out a plausibility check on the basis of the pressure (p) sensed by the second pressure sensor (126b) and a movement (160) detected by the second displacement sensor (106b).
